(19) United States
(12) Patent Application Publication
(10) Pub. No.: US 2014/0109769 A1
(43) Pub. Date: Apr. 24, 2014

(54) Device for Separating Air and Vapor from Liquids

(71) Applicants: Yury TRONIK, Serpukhov (RU); Peter MOULER, Irvine, CA (US); Andrei KALOSHIN, Moscow (RU)

(72) Inventors: Yury TRONIK, Serpukhov (RU); Peter MOULER, Irvine, CA (US); Andrei KALOSHIN, Moscow (RU)

(73) Assignee: ARGOSY TECHNOLOGIES, Palm Desert, CA (US)

(21) Appl. No.: 13/659,327

(22) Filed: Oct. 24, 2012

(51) Int. Cl. B01D 19/00

(52) U.S. Cl. 96/165; 96/189

(57) ABSTRACT

A device for separating air and vapor from liquids has a hollow substantially vertical housing, an inlet provided in the housing for introducing a liquid which contains air and vapor, first outlet for withdrawing from the housing the liquid after separation of air and vapor therefrom and located in a lower area of the housing, a second outlet for withdrawing from the housing the air and vapor separated from the liquid and located in an upper area of the housing, and a separating grate located above the first outlet and intensifying the separation of the air and vapor from the liquid.

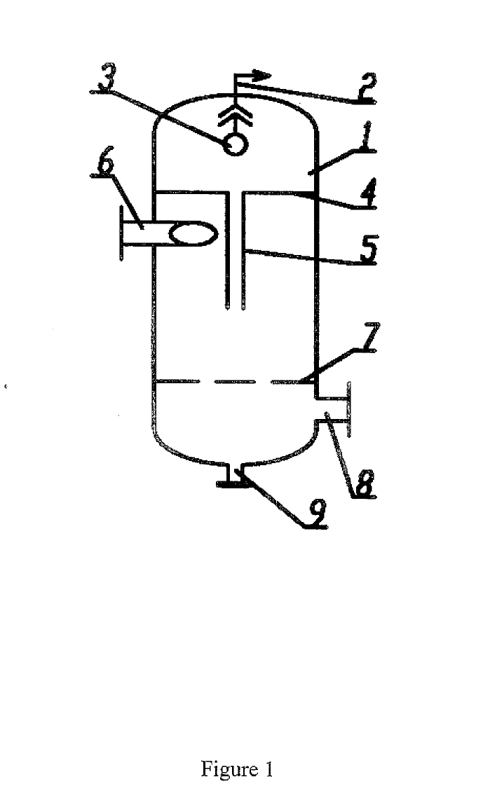

### CROSS REFERENCE TO A RELATED APPLICATION

This application claims its priority from Utility Model application of Russian Federation no. 2011143630/05 filed on Oct. 31, 2011, now patent of Russian Federation RU 116 487 under 35 USC 119 (a)-(d), whose subject matter is incorporated in this application by reference.

### BACKGROUND OF THE INVENTION

The present invention relates to devices for removing air and vapor from liquids, for example in oil supply, oil recovery and oil processing industry.

Devices of the above mentioned type are known in the art. One of such devices is a gas separator GU TU 3683-262-05806720-2007 produced by OAO Prompribor, in Livno, Orel region, Russian Federation, containing a vertical housing, a tangential inlet pipe for introduction of a mixture to be separated, a float-type valve, an air outlet pipe and a liquid outlet pipe. The device has a low of air and vapor efficiency of separation. Also a rotating whirl of liquid above the outlet pipe entrains the separated air.

A centrifugal gas-liquid separator is disclosed in RU 80768 and contains a vertical cylindrical housing with an upper gas discharge pipe, a lower partition, a tangential inlet pipe, a cylindrical sedimentation zone merging into a funnel, a screening truncated cone which expands downwardly toward housing walls and located along a perimeter to a housing with a gap, a liquid discharge pipe, a residue discharge pipe, with a drop-catcher, and a perforated axial pipe concentric with the housing, and other elements. This device however has a low efficiency of gas withdrawal in a perforation of an axial pipe and again—a whirling effect in a zone of the liquid discharging pipe.

RU 101936 discloses a device with a cylindrical housing with a gas discharge pipe in a lower area, tangential inlet pipe with introduction of a mixture, a collector of liquid and dirt, liquid discharge pipe, a drop catcher, a transverse partition, a draining pipe, a second transverse partition, a hydraulic lock with another draining pipe, a gas guiding element and other components, with with the gas guiding element provided with a coalescence unit for increase of drop size. This device is quite complicated, has an insufficient efficiency of air and vapor separation in mixtures with high liquid content, and also liquid whirl about an outlet pipe, which entrains the separated air.

### SUMMARY OF THE INVENTION

Accordingly it is an object of the present invention to provide a device for separation air and vapor from liquids which avoids the disadvantages of the prior art and constitutes a further improvement.

In keeping with these objects and with others which will become apparent hereinafter, one feature of the present invention resides, briefly stated, in a device for separating air and vapor from liquids, which has a hollow substantially vertical housing; an inlet provided in said housing for introducing a liquid which contains air and vapor; a first outlet for withdrawing from said housing the liquid after separation of air and vapor therefrom and located in a lower area of said housing; a second outlet for withdrawing from said housing the air and vapor separated from the liquid and located in an upper area of said housing; and a separating grate located above said first outlet and intensifying the separation of the air and vapor from the liquid.

In accordance with another feature of the present invention, in the device for separating air and vapor from liquids of the invention the separating grate has a plurality of openings with a total area which is at least equal to an area of said first outlet in said housing for withdrawing the liquid therefrom.

Still another feature of the present invention is that the inventive device is provided with a valve arranged in said upper area of said housing and having a float which lowers when a level of the liquid lowers and opens said valve allowing a flow of the air and vapor therethrough outwardly, and which raises when the level of liquid raises and closes said valve.

In accordance with a further feature of the present invention the inventive device for separating air and vapor from liquids further has a draining outlet located in said lower area of said housing for removing residues of the liquid and dirt from said housing.

Still a further feature of the present invention is that in the inventive device for separating air and vapor from liquids the inlet extends substantially transversely or tangentially to a vertical wall of said housing to cause turning of a flow of liquid after entry into said housing.

Also another feature of the present invention resides in that the inventive device for separating air and vapor from liquids further has a guiding tube extending substantially vertically and directing the separated air and vapor toward said valve.

The novel features of the present invention are set forth in particular in the appended claims. The invention itself however , both as to its construction and its manner of operation, will be best understood from the following description of the invention, which is accompanied by the following drawings.

### BRIEF DESCRIPTION OF THE DRAWINGS

The single FIGURE of the drawings is a view showing a new device for separation of air and gas from liquids in accordance with the present invention

### DESCRIPTION OF PREFERRED EMBODIMENTS

A device for separation of air and vapor in accordance with the present invention has a substantially cylindrical vertically extending housing 1. Reference numeral 2 identifies an outlet or an outlet pipe for withdrawal of air and vapors from from an interior of the housing and is located in an upper area of the housing. A pipeline is usually connected with the outlet pipe 2 for supplying the separated air and vapors into a collection system for subsequent use and liquefaction.

The device further has a float-type valve 3 for preventing a flow of liquid into the pipe 2. If there is no sufficient quantity of liquid in the housing, a flow of the valve is suspended and the valve keeps the outlet pipe 2 open so that air and vapors pushed by the raising level of liquid are supplied to the vapor collection system.

A transverse partition 4 is provided for separation of a zone of liquid supply from a zone in which the float-type valve 3 operates. A gas guiding pipe 5 is mounted in the partition and provided for guiding the separated air and vapors into the zone of the float-type valve. Liquid can also flow through this pipe, already in a quite state which does not interfere with the operation of the float-type valve.

A tangential inlet pipe 6 introduces the liquid into the housing transversely to it. It is located along a tangent to the housing 1 below the transverse partition 4 and imparts twisting or turning to a flow of liquid along the housing. A separating grate 7 is located above a liquid withdrawal outlet 8 in a lower area and prevents a creation of rotating liquid whirl along the housing 1. Finally a draining pipe 9 located in the lower area of the housing 1 is used for withdrawal of residues of liquid and dirt during prophylactic and repair works.

The device for separating air and vapors in accordance with the present invention operates in the following manner.

A liquid mixed with air and vapors is supplied into the housing 1 through the tangential inlet pipe 6. When liquid is brought in contact with the inner surface of the housing, it obtains a circular motion along a spiral and is pressed against the wall of the housing 1. Bubbles of air and vapors have a lower specific weight than a liquid, and therefore they are accumulated inside the circular motion of the liquid and are supplied through the gas guiding pipe 5 into an upper area of the housing, wherein the float-type valve 3 and the air and vapor outlet pipe 2 are located. Upon accumulation of air in the upper area of the housing 1, the level of liquid lowers, and the float of the valve 3 lowers as well. The valve 3 opens, and air and vapors are supplied through the outlet 2 into the withdrawing pipeline. During the process of withdrawal of air and vapors the level of liquid in the housing 1 raises, and the float-type valve 3 closes an opening in the air and vapor outlet pipe 2.

The transverse partition 4 with the gas guiding pipe 5 prove a directional twisting of the liquid along the wall of the housing 1. The separating grate 7 in the lower area above the liquid withdrawing outlet pipe 8 intensifies the separation of the air and vapor bubbles from the liquid. They gradually accumulate, gather on its surface into larger bubbles, and moves upwards along the gas guiding pipe 5 into the upper area of the housing, to be withdrawn through the outlet pipe 2.

The separating grate is substantially horizontal and a total area of its through openings is not less than an area of a cross section of the outlet pipe 8. It also prevents a whirling of liquid above the outlet 8, thus facilitating liquid withdrawal through it.

The present invention is not limited to the details shown since various modifications and structural changes are possible without departing from the spirit of the invention.

What is desired to be protected by Letters Patent is set forth in particular in the appended claims.

1. A device for separating air and vapor from liquids, comprising
a hollow substantially vertical housing;
an inlet provided in said housing for introducing a liquid which contains air and vapor;
a first outlet for withdrawing from said housing the liquid after separation of air and vapor therefrom and located in a lower area of said housing;
a second outlet for withdrawing from said housing the air and vapor separated from the liquid and located in an upper area of said housing; and
a separating grate locate above said first outlet and intensifying the separation of the air and vapor from the liquid.

2. A device for separating air and vapor from liquids as defined in claim 1, wherein said separating grate has a plurality of openings with a total area which is at least equal to an area of said first outlet in said housing for withdrawing the liquid therefrom.

3. A device for separating air and vapor from liquids as defined in claim 3, further comprising a valve arranged in said upper area of said housing and having a float which lowers when a level of the liquid lowers and opens said valve allowing a flow of the air and vapor therethrough outwardly, and which raises when the level of liquid raises and closes said valve.

4. A device for separating air and vapor from liquids as defined in claim 1, further comprising a draining outlet located in said lower area of said housing for removing residues of the liquid and dirt from said housing.

5. A device for separating air and vapor from liquids as defined in claim 1, wherein said inlet extends substantially transversely to a vertical wall of said housing to cause turning of a flow of liquid after entry into said housing.

6. A device for separating air and vapor from liquids as defined in claim 3, further comprising a guiding tube extending substantially vertically and directing the separated air and vapor toward said valve.
